(19) United States
(12) Patent Application Publication
(10) Pub. No.: US 2025/0106727 A1
(43) Pub. Date: Mar. 27, 2025

(54) METHOD PERFORMED BY COMMUNICATION NODE AND COMMUNICATION NODE IN COMMUNICATION SYSTEM

(71) Applicant: Samsung Electronics Co., Ltd., Gyeonggi-do (KR)

(72) Inventors: Weiwei WANG, Beijing (CN); Hong WANG, Beijing (CN); Lixiang XU, Beijing (CN)

(21) Appl. No.: 18/730,919

(22) PCT Filed: Jan. 20, 2023
(86) PCT No.: PCT/KR2023/001054

§ 371 Date: Jul. 22, 2024

(30) Foreign Application Priority Data
Jan. 21, 2022 (CN) 202210074513.1
Aug. 9, 2022 (CN) 202210958542.4

(51) Int. Cl. H04W 40/12; H04W 88/04

(52) U.S. Cl. CPC H04W 40/12; H04W 88/04

(57) ABSTRACT

The disclosure relates to a 5G or 6G communication system for supporting a higher data transmission rate. A method performed by a first node in a communication system includes receiving first information related to path configuration from other nodes and/or sending information related to link failure to a fourth node. The first information includes path configuration information. The information related to link failure includes at least one of: link failure type indication information including at least one of: direct path failure indication information, indirect path failure indication information, failed path indication information or link failure cause information.

### TECHNICAL FIELD

The present disclosure relates to the field of communication, and more particularly, to a mechanism for configuring communication and a corresponding node.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

According to an embodiment, a method performed by a fourth node in a communication system is provided. The method may comprise sending first information related to path configuration to a first node. The first information includes at least one of sixth path configuration information used to configure a path for the first node, second primary path configuration information used to indicate configuration information for one or more primary paths, path state indication information used to indicate a state of one or more paths, second state indication information used to indicate a state of a packet data convergence protocol (PDCP) duplication function, or eighth condition indication information used to indicate a condition for enabling a path.

According to an embodiment, a method performed by a first node in a communication system is provided, the method comprises receiving fourth information related to path configuration from other nodes, and sending information related to link failure to a fourth node. The fourth information includes path configuration information. The information related to link failure includes at least one of link failure type indication information or link failure cause information. The link failure type indication information includes at least one of direct path failure indication information, indirect path failure indication information, failed path indication information or link failure cause information.

According to an embodiment, a method performed by a third node in a communication system is provided. The method comprises receiving second information related to path configuration from a fourth node, sending third information related to path configuration to the fourth node, and sending first information related to path configuration to a first node. The first information is determined based on at least one of the second information and the third information.

According to an embodiment, a node device is provided. The node device comprises a transceiver; and a processor configured to send first information related to path configuration to a first node. The first information includes at least one of sixth path configuration information used to configure a path for the first node, second primary path configuration information used to indicate configuration information for one or more primary paths, path state indication information used to indicate a state of one or more paths, second state indication information used to indicate a state of a packet data convergence protocol (PDCP) duplication function, or eighth condition indication information used to indicate a condition for enabling a path.

### BRIEF DESCRIPTION OF DRAWINGS

The above and other aspects, features, and advantages of the present disclosure will be more apparent from the following detailed description when taken in conjunction with the accompanying drawings, in which:

FIG. 1 an exemplary system architecture of system architecture evolution (SAE) according to an embodiment;

FIG. 2 is an example of an exemplary system architecture according to an embodiment;

FIG. 3 is an example of a base station structure according to an embodiment;

FIG. 4 is an example of a first procedure according to an embodiment;

FIG. 5 is an example of a second procedure according to an embodiment;

FIG. 6 is an example of a third procedure according to an embodiment;

FIG. 7 is an example of a fourth procedure according to an embodiment;

FIG. 8 is an example of a fifth procedure according to an embodiment;

FIG. 9 is an example of a sixth procedure according to an embodiment;

FIG. 10 is a simplified hardware block diagram of a communication device according to an embodiment of the disclosure;

FIG. 11 illustrates a structure of a UE according to an embodiment of the disclosure; and

FIG. 12 illustrates a structure of a base station according to an embodiment of the disclosure.

### BEST MODE FOR CARRYING OUT THE INVENTION

In an NR (New Radio access) network, data communication can be performed between two user equipments through a sidelink, and then a user can also communicate with a base station. In order to expand a coverage of the base station and improve the performance of user data transmission, a user equipment can also be allowed to access the network through other user equipments. This technology is sidelink relay technology.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

It should be understood that, in the following description, for the convenience of description, descriptions such as “terminal”, “user terminal”, “user equipment”, “user”, “UE”, etc. are flexibly used. It can be understood that, these descriptions all mean the same or equivalent meaning, so they can be used interchangeably. In addition, flexibly used expressions such as “relay”, “relay terminal”, “relay user terminal”, “relay UE”, “relay user equipment”, “relay user”, “relay device”, etc. are only used for the convenience of expression. These expressions can be used interchangeably, and they all represent devices that play roles in an indirect path between a remote user equipment and a base station. In addition, in the following description, “path” and “link” can be used interchangeably.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

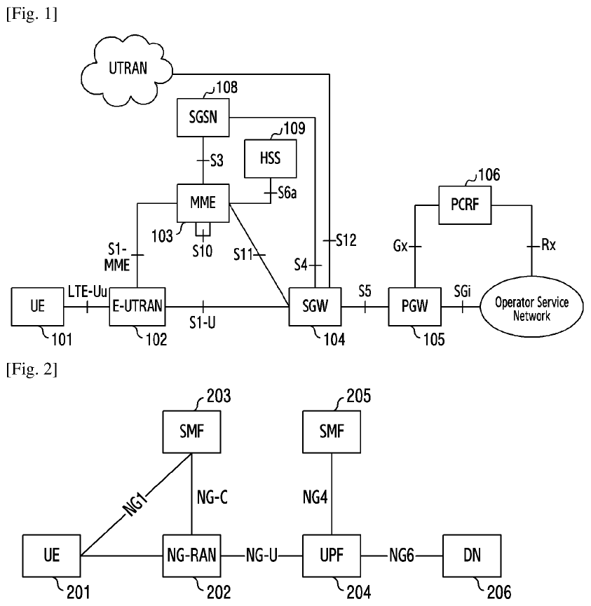

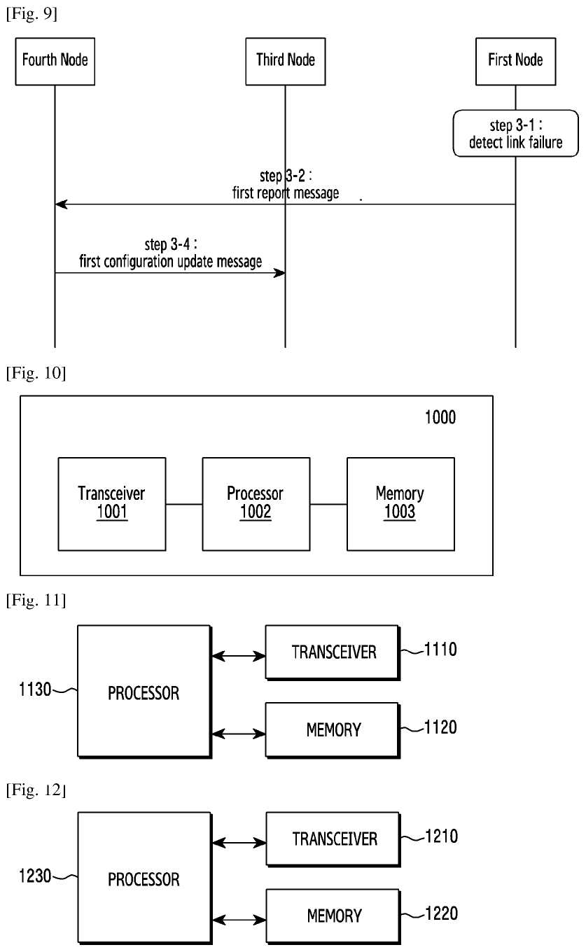

FIG. 1 to FIG. 12 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transport in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the CNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

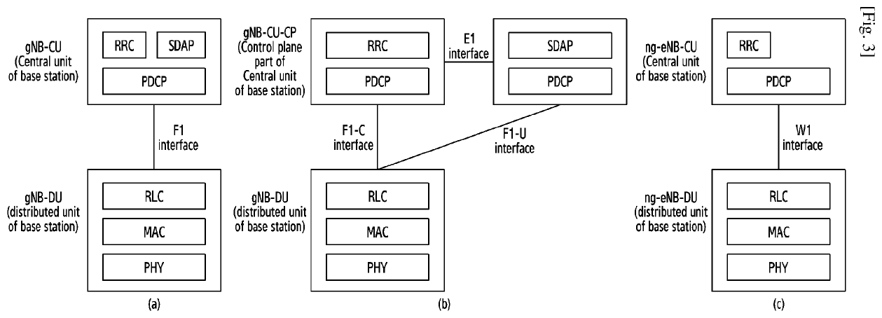

In an NR system, in order to support network function virtualization, more efficient resource management and scheduling, a base station (gNB/ng-eNB) providing wireless network interface for a terminal (UE) may be further divided into a central unit gNB-CU/ng-eNB-CU (gNB central unit/ng-eNB central unit) and a distributed unit gNB-DU/ng-eNB-DU (gNB distributed unit/ng-eNB distributed unit) (abbreviated as CU and DU in the invention), as shown in (a) of FIG. 3. The gNB-CU has radio resource control (RRC), service data adaptation protocol (SDAP) and packet data convergence protocol (PDCP) protocol layers, and the like, and the ng-eNB-CU has RRC and PDCP layers. The gNB-DU/ng-eNB-DU has radio link control protocol (RLC), medium access control (MAC) and physical layers, and the like. There is a standardized public interface F1 between gNB-CU and gNB-DU, and a standardized public interface W1 between ng-eNB-CU and ng-eNB-DU. The F1 interface is divided into a control plane F1-C and a user plane F1-U. The transport network layer of F1-C is based on IP transmission. In order to transmit signalling more reliably, SCTP protocol is added over IP. The application layer protocol is F1AP, seeing 3GPP TS38.473. SCTP may provide reliable application layer message transmission. The transport layer of F1-U is UDP/IP, and GTP-U is used to carry user plane protocol data unit (PDU) over UDP/IP. Further, for gNB-CU, as shown in (b) of FIG. 3, the gNB-CU may include gNB-CU-CP (a control plane part of the central unit of the base station) and gNB-CU-UP (a user plane part of the central unit of the base station). The gNB-CU-CP contains the function of the control plane of the base station and has RRC and SDAP protocol layers, and gNB-CU-UP contains the function of the user plane of the base station and has SDAP and PDCP protocol layers. There is a standardized public interface E1 between gNB-CU-CP and gNB-CU-UP, and the protocol is E1AP, seeing 3GPP TS38.463. The interface between the control plane part of the central unit of the base station and the distributed unit of the base station is F1-C interface, that is, a control plane interface of F1, and the interface between the user plane part of the central unit of the base station and the distributed unit of the base station is F1-U interface, that is, a user plane interface of F1. In addition, in the NR system, the base station which provides E-UTRA user plane and control plane and accesses to a 5G core network is called ng-eNB. In order to support virtualization, such base station (ng-eNB) may also be further divided into a central unit ng-eNB-CU (gNB central unit/ng-eNB central unit) and a distributed unit ng-eNB-DU (abbreviated as CU and DU in the invention), as shown in (c) of FIG. 3. The ng-eNB-CU has RRC and PDCP layers. The gNB-DU/ng-eNB-DU has radio link control protocol (RLC), medium access control (MAC) and physical layers, and the like. There is a standardized public interface W1 between ng-eNB-CU and ng-eNB-DU. W1 interface is divided into a control plane W1-C and a user plane W1-U. The transport network layer of W1-C is based on IP transmission. In order to transmit signalling more reliably, SCTP protocol is added over IP. The application layer protocol is W1AP, seeing 3GPP TS37.473. The transport layer of W1-U is UDP/IP, and GTP-U is used to carry user plane protocol data unit (PDU) over UDP/IP.

Usually, a user equipment communicates through a direct path with a base station. However, with the increase of users and the increase of cell frequency, the coverage of the cell is limited, and the data transmission rate provided by the cell is limited. Sidelink relay technology is proposed to solve this problem, that is, the base station can communicate with the user equipment through a relay terminal. In the prior art, the connection between the user terminal and the network is either made through an air interface link (direct path) directly connected to the network or through a relay terminal (indirect path), thus, it is necessary to enhance the connection between the user terminal and the network, so that the user terminal communicates with the network more flexibly. In the embodiments of the invention, the configuration of multiple communication paths of the user terminal is realized, for example, the relay terminal makes it through the direct path and the indirect path at the same time, thereby realizing more flexibly communication of the user terminal with the network through multiple paths, and improving the reliability and throughput of data transmission. Specifically, the invention relates to the following aspects:
configuration of communication paths
reporting and recovery of communication link failure.

Exemplary embodiments of the disclosure are further described below with reference to the accompanying drawings.

The text and drawings are only provided as examples to help understand the disclosure. They should not be construed as limiting the scope of the disclosure in any way. Although some embodiments and examples have been provided, based on the disclosure herein, it is obvious to those skilled in the art that changes can be made to the illustrated embodiments and examples without departing from the scope of the disclosure.

Before introducing the specific content, some assumptions and some definitions of the invention are given below.
The message names in the invention are only examples, and other message names may be used.
The “first”, “second” included in the message names of the invention are only examples of the messages, and do not represent the performing order.
The detailed description of steps unrelated to the invention is omitted in the invention.
In the invention, the steps in each process may be performed in combination with each other or independently. The performing steps of each process are only examples, and other possible performing orders or possibility of parallel performing are not excluded.
In the invention, the base station may be a 5G base station (such as gNB, ng-eNB), a 4G base station (such as eNB), or other types of access nodes.
In the invention, transmission/transmitting of data refers to reception or sending of data.
In the invention, uplink data refers to the data sent by the relay user terminal or remote user terminal to the base station, and downlink data refers to the data sent by the base station to the relay user terminal or remote user terminal.

The nodes to which the invention relates are:
a first node: a user terminal, such as remote UE. In an embodiment, the user terminal may communicate with a base station directly. In another embodiment, the user terminal may communicate with the base station through other terminals (e.g., relay terminals). In another embodiment, the user terminal may communicate with the base station both directly and through other terminals.
a second node: a relay terminal, such as relay UE, which communicates with the base station directly and can provide relay services for other terminals, that is, other terminals may communicate with the base station through the relay terminal.
a third node: a distributed unit of the base station. The above second node will send data of the first node to the third node, or the above second node sends data of the third node to the first node, or the above first node or second node may perform data transmission with the third node directly.
a fourth node: a centralized unit of the base station, or a centralized unit control plane part of the base station, or a centralized unit user plane part of the base station.

The above third node and fourth node constitute a base station serving the first node and a base station performing data transmission with the second node.

Further, when the centralized unit of the base station includes a control plane part and a user plane part, it also relates to:
a fifth node: the control plane part of the centralized unit of the base station.
a sixth node: the user plane part of the centralized unit of the base station.

The invention relates to two communication paths:
a direct path or a direct link: the direct path indicates a path through which the user terminal performs data transmission with the network. On the path, the user terminal is directly connected to the network (such as through an air interface link between the user terminal and the network), and data is transmitted on the path.
an indirect path or an indirect link: the indirect path indicates another path through which the user terminal performs data transmission with the network. On the path, there is another terminal (such as relay terminal) on the connection between the user terminal and the network. In an example, there is a sidelink or PC5 link between the user terminal and the other terminal, and there is an air interface link (Uu link) between the other terminal and the network, and the data transmission between the user terminal and the network is relayed through the other terminal.

In the following description, the expressions “direct path” and “direct link” are equivalent, the expressions “indirect path” and “indirect link” are equivalent, and the expressions “path” and “link” are equivalent.

After considering the relay terminal, the communication between the user terminal and the network may have the following scenarios:
Scenario 1 (adding an indirect path): the user terminal establishes a direct path with the network, and then the network adds an indirect path for the user terminal. Further, a cell serving the direct path and a cell serving the indirect path (such as a cell serving the relay terminal on the indirect path) may be the same or different (the different cells may belong to the same base station or a distributed unit of the same base station, or different base stations or different distributed units of the same base station or different distributed units of different base stations).
Scenario 2 (adding a direct path): the user terminal is communicating with the network through an indirect path, and then the network adds a direct path for the user terminal. Further, a cell serving the direct path and a cell serving the indirect path (such as a cell serving the relay terminal on the indirect path) may be the same or different (the different cells may belong to the same base station or a distributed unit of the same base station, or different base stations or different distributed units of the same base station or different distributed units of different base stations).
Scenario 3 (configuring a direct path and an indirect path at the same time): the network configures the direct path and the indirect path for the user terminal at the same time. Further, a cell serving the direct path and a cell serving the indirect path (such as a cell serving the relay terminal on the indirect path) may be the same or different (the different cells may belong to the same base station or a distributed unit of the same base station, or different base stations or different distributed units of the same base station or different distributed units of different base stations). In an embodiment, in the process of handover, the network configures the direct path and the indirect path at the same time for the user terminal in a target cell; in another embodiment, in the process of establishing dual connectivity, the network configures the direct path and the indirect path at the same time for the user terminal in a cell of a primary base station or a secondary base station or another distributed unit.
Scenario 4 (configuring an indirect path in a target cell): in the process of switching the user to the target cell, the network configures the indirect path for the user terminal in the target cell, and the user terminal may communicate through a direct path and/or an indirect path in a source cell.
Scenario 5 (configuring a direct path in a target cell): in the process of switching the user to the target cell, the network configures the direct path for the user terminal in the target cell, and the user terminal may communicate through a direct path and/or an indirect path in a source cell.

The above scenarios indicate that the configuration of the communication path of a user terminal may include the following situations:
new path(s) addition
path update/change/switch
multiple paths configuration at the same time

The invention defines the following information, which will be used in signalling interaction between nodes.

Path configuration information, which is used to indicate configuration information for a path, and includes at least one of:
path identification information
path type information, which indicates a type of the path, such as direct path, indirect path.
cell identification information, which indicates a cell serving the path. In an example, the cell is a cell serving the user terminal (such as primary cell or primary secondary cell). In another example, the cell is a cell accessed by the relay terminal on the indirect path.
identification information of a relay terminal, which indicates the relay terminal on the path, and is used when configuring a new indirect path for the user. The identification information may be an identification of the user on an interface (such as F1interface), an identification of layer 2, 5G-S-TMSI, or C-RNTI, etc.
timer information, which indicates a maximum value of time required for the user to access the path. In an embodiment, if the user terminal does not access the path within the time indicated by the information, it may be considered that the user has failed to access the path, and then the user terminal is required to start a reestablishment procedure. When the path is a direct path, an example of the timer is T304, and when the path is an indirect path, the timer may be a new timer.
path characteristic indication information, which is used to indicate whether the path is a primary path or whether the path is a secondary path. As for the difference between the primary path and the secondary path, an example is that the secondary path can be enabled only after a certain condition (such as at least one of an amount of transmitted data reaching a certain threshold, signal quality of the secondary path reaching a certain threshold, a rate of the secondary path reaching a certain threshold, time delay of data transmission reaching a certain threshold, etc.) is satisfied.
first path state information, which is used to indicate whether the path is available, or is activated (only the activated path can be used for data transmission). In an embodiment, the information indicates an initial state of the path, that is, a state when the path is just configured.
first path maintenance information, which is used to indicate whether to maintain data transmission on other paths. The information may indicate maintenance of the direct path, maintenance of the indirect path, or identification information of the maintained path.

Path indication information, which indicates a path used to transmit data. In an example, the information indicates a path of uplink data. In another example, the information indicates a path of downlink data. In another embodiment, the information indicates a path of the uplink and downlink data when the same path is employed for the uplink data and the downlink data. In another example, the information may also be used to indicate an uplink path and a downlink path respectively when different paths are employed for the uplink data and the downlink data. The information includes at least one of:
path identification information, which indicates an identification of the used path.
path flag information, which indicates a path used to transmit data, such as direct path, indirect path, or both.
second path state information, which is used to indicate whether the path for transmitting data is available or activated (only the activated path can be used for data transmission).
second path maintenance information, which is used to indicate whether to maintain data transmission on other paths. The information may indicate maintenance of the direct path, maintenance of the indirect path, or identification information of the maintained path.

Condition indication information, which is used to indicate condition information for enabling a path. The information may be used to indicate condition information for enabling a secondary path, condition information for enabling a primary path, condition information for enabling a direct path, condition information for enabling an indirect path, or condition information for enabling a specific path (in this example, the “condition indication information” may also include identification information of the path). Further, the condition indication information may be used to indicate a condition for enabling the path to transmit uplink data, a condition for enabling the path to transmit downlink data, and a condition for enabling the path to transmit uplink and downlink data. The condition indicated by the information may be at least one of:
an amount of transmitted data being greater than (or less than, or greater than or equal to, or less than or equal to) a threshold, the “condition indication information” may also include the threshold.
signal quality being greater than (or less than, or greater than or equal to, or less than or equal to) a threshold, the “condition indication information” may also include the threshold.
data transmission rate being greater than (or less than, or greater than or equal to, or less than or equal to) a threshold, the “condition indication information” may also include the threshold.
time delay of data transmission being greater than (or less than, or greater than or equal to, or less than or equal to) a threshold, the “condition indication information” may also include the threshold.

In the invention, the primary path may be a path indicated by the network through configuration information, for example, the configuration information may indicate which path is the primary path, or the primary path may be the first path configured to the user.

In order to realize the above configuration of the communication paths, the invention includes the following procedures:

### Procedure 1: The Network Side Configures a Path for Serving the User Terminal

After the introduction of the sidelink relay technology, a choice is added for the communication path between the user terminal and the network, that is, the communication is performed with the network through a relay terminal. The invention proposes a configuration method, which includes the following procedures, as shown in FIG. 3:

Step 1-1: the fourth node sends a first configuration message to the third node, which is used to provide related information of the communication path, and includes at least one of:
first path configuration information, which indicates information of a new path configured for the user terminal. In an embodiment, the information is used when changing the communication path of the user terminal, that is, the new path will replace the existing path used by the user terminal, as used in the above scenario 4/5. In an example, the information may be named path switch configuration, or other names may be used. For the content contained in the information, the above “path configuration information” may be referred to.
second path configuration information, which indicates information of a new path added for the user. In an embodiment, when the user terminal has been configured with a communication path, the information may be used to indicate information of a new communication path added for the user, as used in the above scenario 1/2. In an example, the information may be named as additional path information, or direct path information, or indirect path information, or other names can be used. For the newly added path, as to the content contained in the information, the above “path configuration information” may be referred to. In an embodiment, if the information does not contain a SpCell ID, it indicates that a SpCell ID used by the path added by the information is the same as a SpCell accessed by a current user (or accessed by a relay user to which the current user accesses, or to be accessed by the current user, or accessed by a relay node to which the current user prepares to access, or to be accessed by the relay user to which the current user accesses). If the information contains the SpCell ID, it indicates that a SpCell used by the newly added path (such as a SpCell used by the direct path or a SpCell used by the relay user on the indirect path) is a cell indicated by the above SpCell ID.
third path configuration information, which indicates information of more than one path added for the user at the same time. One example is the above scenario 3, another example is adding more than one indirect path, and the other example is adding more than one different path. For any of these paths, as to the content contained in the information, the above “path configuration information” may be referred to. Further, the information may be used to indicate configuration information of all paths added for the user.
path release indication information, which indicates a released path, that is, a path that no longer serves the user terminal. For the released path, the information includes at least one of:
path identification information. In an embodiment, the information may be identification information of a released path. In another embodiment, the information may include identification information of more than one released path.
indication information for releasing a direct path
indication information for releasing an indirect path
indication information for releasing a relay terminal, which further indicates to release an indirect path related to the relay terminal.
indication information for releasing an SpCell (Special Cell), which is used to indicate to release the SpCell serving the user terminal. Further, the indication information may indicate an ID of the SpCell (which may a PCell (Primary Cell) or a PSCell (primary secondary cell). In an example, if the SpCell is a cell serving the relay terminal, the indication information may be used to indicate to release an indirect path served by the cell. In an example, if the SpCell is a cell serving the direct path of the user terminal, the indication information may be used to indicate to release the direct path. In an example, if the SpCell is both the cell serving the direct path of the user terminal and the cell serving the relay terminal, the indication information may further include indication information for releasing the direct path, indication information for releasing the indirect path, indication information for releasing the relay terminal, or indication information for releasing the direct path and the indirect path.
indication information of information of a released path, which indicates information of the released path, such as identification information of the SpCell, and/or identification information of the relay user, etc.
first condition information, which is used to indicate the condition information for enabling a transmission path. For the content contained in the information, the above “condition indication information” may be referred to, and the third node may determine the used path according to the configuration in the information.
first data transmission configuration information, which is used to provide configuration information required for data transmission serving the user terminal to the third node, and includes at least one of:
radio bearer identification information, such as DRB ID, SRB ID
radio bearer QoS information
first mapping information, which indicates resources used to transmit data, such as air interface RLC channel identification information, and/or logical channel identification information, etc. Further, the information may also implicitly indicate that the third node can use an indirect path for data transmission.
first path indication information, which indicates a path used to transmit data (such as data indicated by the above radio bearer identification information). In an example, the information indicates a path of uplink data. In another example, the information indicates a path of downlink data. In another embodiment, the information indicates a path of the uplink and downlink data when the same path is employed for the uplink data and the downlink data. In another example, the information may also be used to indicate an uplink path and a downlink path respectively when different paths arc employed for the uplink data and the downlink data. For an indicated path, as to the content contained in the information, the above “path indication information” may be referred to.
second condition information, which is used to indicate condition information for enabling a transmission path to serve a bearer identified by the above “radio bearer identification information”. For the specific description of the information, the above “condition indication information” may be referred to.
first tunnel information, which indicates configuration information of a tunnel serving a radio bearer at the fourth node side, and may include information of one or more tunnels. For one tunnel, the information includes at least one of:
transport layer address information, such as IP address
tunnel endpoint identification information, such as tunnel endpoint ID
second mapping information, which indicates resources used to transmit data, such as air interface RLC channel identification information, logical channel identification information, etc., and may also implicitly indicate that the data is transmitted using an indirect path.
second path indication information, which indicates a path used to transmit data, which may be data carried by the above tunnel, such as data carried on the tunnel indicated by the above transport layer address and/or tunnel endpoint identification information, or data carried on a downlink tunnel corresponding to the tunnel indicated by the above transport layer address and/or tunnel endpoint identification information, and the path indicated by the indication information may be a direct path, or an indirect path, or the direct path and the indirect path, or path identification information. In an example, the information indicates a path of uplink data. In another example, the information indicates a path of downlink data. In the other embodiment, the information indicates a path of the uplink and downlink data. Further, when different paths are used for the uplink data and the downlink data, the information may also be used to include path indication information of the uplink data (such as the direct path, the indirect path, or the direct path and the indirect path, or identification information of the path) and path indication information of the downlink data (such as the direct path, the indirect path, or the direct path and the indirect path, or identification information of the path), and for the content contained in the information, the above “path indication information” may be referred to.
third condition information, which is used to indicate condition information for enabling a transmission path to serve data on a tunnel. For the specific description of the information, the above “condition indication information” may be referred to.
first signalling transmission configuration information, which is used to indicate path information of transmission signalling (such as RRC signalling), and includes at least one of:
a first signalling container, which contains signalling sent by the fourth node to the user terminal, such as RRC signalling or a PDCP PDU containing the RRC signalling.
third path indication information, which indicates a path used to transmit the signalling in the first signalling container. For the content contained in the information, the above “path indication information” may be referred to.
fourth condition information, which is used to indicate condition information for enabling a path to transmit the signalling in the above “first signalling container”. For the specific description of the information, the above “condition indication information” may be referred to.
first measurement information, which is used to provide the third node with measurement information of the user terminal, such as a measurement result of the user terminal for at least one relay terminal. For a relay terminal, the information includes at least one of:
cell identification information, which identifies a cell serving the measured relay terminal.
identification information of a relay terminal, which indicates the measured relay terminal. The identification information may be identification of the user on an interface (such as F1 interface), identification of layer 2, 5G-S-TMSI, or C-RNTI, etc.
measurement result information, such as RSRP, RSRQ, etc.

Step 1-2: the third node sends a first configuration response message to the fourth node, which is used to provide configuration information on the communication path at the third node side, and includes at least one of:
path configuration result information, which is used to indicate whether the third node accepts a new path, for example, whether the path indicated by the “first path configuration information”, the “second path configuration information” or the “third path configuration information” in the above step 1-1 is accepted by the third node.
fifth path configuration information, which indicates a new path selected by the third node. The path may be a newly added path or a new path replacing the existing path. For the content of the information, the above “path configuration information” may be referred to. Further, the new path targeted by the configuration information may be determined according to the “first measurement information” received in step 1-1. In an embodiment, the new path selected by the third node may be configured according to the information provided by the fourth node in step 1-1 (such as the above “first measurement information”).
first primary path configuration information, which indicates configuration information for a primary path generated by the third node. The primary path may be a direct path, or an indirect path. In an embodiment, the third node may determine which path is the primary path according to the information received in step 1-1 (such as the “path characteristic indication information” contained in any of the first/second/third path configuration information). In another embodiment, the third node decides which path is the primary path by itself. The primary path may be a primary path with respect to all data, a primary path with respect to partial data (such as data carried by an SRB, data carried by a DRB), a primary path with respect to a radio bearer, or a primary path with respect to a tunnel. For a primary path, the information includes at least one of:
logical channel identification information, a logical channel identified by the information is for the primary path, and may be a logical channel on an air interface link or a logical channel on a sidelink.
RLC entity identification information, an RLC entity identified by the information is for the primary path, and may be an RLC entity on an air interface link or an RLC entity on a sidelink.
fifth condition information, which is used to indicate the condition information for enabling a transmission path. For the content contained in the information, the above “condition indication information” may be referred to. The condition information is determined by the third node. In an embodiment, the condition information may be condition information determined by the third node when the “first condition information” is not provided in step 1-1.
second data transmission configuration information, which is configuration information on data at the third node side, and includes at least one of:
radio bearer identification information, such as DRB ID and SRB ID. In an embodiment, a radio bearer indicated by the identification information may be a bearer accepted by the third node.
third mapping information, which indicates resources used to transmit data, such as air interface RLC channel identification information, logical channel identification information, etc. Further, the information may also implicitly indicate that the third node can use an indirect path for data transmission. In addition, the information also indicates that the third node decides the mapping.
fourth path indication information, which indicates a path used to transmit data (such as data indicated by the above radio bearer identification information). In an example, the information indicates a path of uplink data. In another example, the information indicates a path of downlink data. In another embodiment, the information indicates a path of the uplink and downlink data when the same path is employed for the uplink data and the downlink data. In another example, the information may also be used to indicate an uplink path and a downlink path respectively when different paths are employed for the uplink data and the downlink data. For an indicated path, as to the content contained in the information, the above “path indication information” may be referred to. In addition, the information also indicates that the third node decides the path.
sixth condition information, which is used to indicate condition information for enabling a transmission path to serve a bearer identified by the above “radio bearer identification information”. For the specific description of the information, the above “condition indication information” may be referred to. In addition, the information also indicates that a condition for using a certain transmission path is determined by the third node. In an embodiment, the condition information may be condition information determined by the third node when the “second condition information” is not provided in step 1-1.
second tunnel information, which indicates configuration information of a tunnel serving a radio bearer at the third node side, and may include information of one or more tunnels. For one tunnel, the information includes at least one of:
transport layer address information, such as IP address
tunnel endpoint identification information, such as tunnel endpoint ID
fourth mapping information, which indicates resources used to transmit data, such as air interface RLC channel identification information, logical channel identification information, etc., and may also implicitly indicate that the data is transmitted using an indirect path.
fifth path indication information, which indicates a path used to transmit data, which may be data carried by the above tunnel, such as data carried on the tunnel indicated by the above transport layer address and/or tunnel endpoint identification information, or data carried on a downlink tunnel corresponding to the tunnel indicated by the above transport layer address and/or tunnel endpoint identification information, and the path indicated by the indication information may be a direct path, or an indirect path, or the direct path and the indirect path, or path identification information. In an example, the information indicates a path of uplink data. In another example, the information indicates a path of downlink data. In another embodiment, the information indicates a path of the uplink and downlink data. Further, when different paths are used for the uplink data and the downlink data, the information may also be used to include path indication information of the uplink data (such as the direct path, the indirect path, or the direct path and the indirect path, or identification information of the path) and path indication information of the downlink data (such as the direct path, the indirect path, or the direct path and the indirect path, or identification information of the path), and for the content contained in the information, the above “path indication information” may be referred to
seventh condition information, which is used to indicate condition information for enabling a transmission path to serve data on a tunnel. For the specific description of the information, the above “condition indication information” may be referred to. In an embodiment, the condition information may be condition information determined by the third node when the “third condition information” is not provided in step 1-1.
link configuration information, which provides configuration information required for serving the user terminal at the third node side. Such configuration information will be sent to the user terminal (for example, sent to the user terminal by the fourth node). The link configuration information includes at least one of:
air interface link configuration information, which indicates configuration information of an air interface link between the third node and the user terminal, e.g., at least one of RLC configuration information, MAC layer configuration information, PHY layer configuration information, such as configuration information in Cell-GroupConfig.
sidelink configuration information, which indicates configuration information used by the user terminal on the sidelink, e.g., at least one of RLC configuration information of the sidelink, MAC layer configuration information of the sidelink, PHY layer configuration information of the sidelink, such as configuration information in SL-PHY-MAC-RLC-Config.

Further, after receiving the first configuration response message, the fourth node may also send at least one of the above information contained in the message to the user terminal, to configure the path required for serving data transmission for the user terminal.

According to the above “first data transmission configuration information” or “first signalling transmission configuration information” or “second data transmission configuration information”, the data transmission of the user terminal may be realized in the following methods:

### Method 1: Configuring a Transmission Path Based on a Radio Bearer

In this method, each radio bearer may be configured with a transmission path, which may be configured to be transmitted only using a direct path, only using an indirect path, or using the direct path and the indirect path.

### Method 2: Configuring a Transmission Path Based on a Tunnel

In this method, a tunnel serving each radio bearer may be configured with a transmission path, which may be configured to be transmitted only using a direct path, only using an indirect path, or using the direct path and the indirect path. The difference between this method and method 1 is that when a radio bearer is configured with more than one tunnel (for example, in order to support PDCP duplication, a radio bearer may be configured with two or more tunnels), each tunnel may be configured with the used transmission path separately (that is, different tunnels serving a radio bearer may be configured with different paths). When a bearer has only one tunnel, method 1 and method 2 are the same. If the direct path and the indirect path are configured, then data of a tunnel may be transmitted through two paths.

### Method 3: Configuring a Transmission Path Based on a Packet

In this method, each packet (such as a packet sent by the fourth node to the third node, and in an embodiment, the packet may be a packet containing the above “first signalling container” or a packet on a tunnel) may be configured with a transmission path, which, for example, may be configured to be transmitted only using a direct path, only using an indirect path, or using the direct path and the indirect path.

In addition, when data of a bearer is configured to be transmitted by more than one path (such as direct path and indirect path), more than one tunnel may be configured for the bearer, each tunnel being configured with a transmission path. In this way, when the third node receives information of more than one tunnel corresponding to a bearer through the first configuration message, the third node is not required to configure more than one RLC entity for the bearer, so that the resources at the third node can be saved. If the fourth node provides information of more than one tunnel to the third node, the third node is required to configure more than one RLC entity. This mechanism is to support a PDCP duplication function. In the invention, for one or more tunnels involved in the indirect path, the third node is not required to configure RLC entities serving air interface data transmission for these tunnels, but is only required to configure RLC entities serving air interface data transmission for the tunnels served by the direct path. That is, in the mechanism of the invention, if a bearer is configured with more than one tunnel, and data of one or more tunnels is configured to be transmitted using the indirect path (one method is to explicitly indicate that the path used to transmit the data of the tunnel is the indirect path, and another method is to implicitly indicate by configuring a mapped resource for the tunnel, such as the above “second mapping information”), the third node is not required to generate as many RLC entities as the number of the tunnels, but is only required to configure an RLC entity used to serve the data of the tunnel corresponding to the direct path.

Based on the above steps, the third node and the fourth node may generate the configuration information for serving the user terminal, which may include configuration information required for serving the user using the direct path or configuration information required for serving the user using the indirect path. Further, the fourth node may also generate the configuration information for the user terminal, and send such configuration information to the user terminal. For the configuration of the user terminal, the description of the following procedure 2 may be referred to.

It should be understood that, although in the above description and in the drawings, step 1-2 is described as being after step 1-1, it should be understood that this is only exemplary. The method of the application may include only step 1-1, only step 1-2, or both steps 1-1 and 1-2. When both steps 1-1 and 1-2 are included, the order of steps 1-1 and 1-2 may be that step 1-1 is first, and then followed by step 1-2, or step 1-2 is first, and then followed by step 1-1, or the two steps may be simultaneously performed substantially. All these methods can realize the configuration of the transmission path of the user terminal.

Therefore, it should be understood that, each step mentioned in the description throughout the disclosure is not limited to the order described or shown in the drawings, nor does it mean that all described or shown steps are necessary. Instead, the described and shown steps may be performed in a reverse order or simultaneously, or only some of these steps may be performed to realize the technical solution of the application, unless the context clearly indicates otherwise.

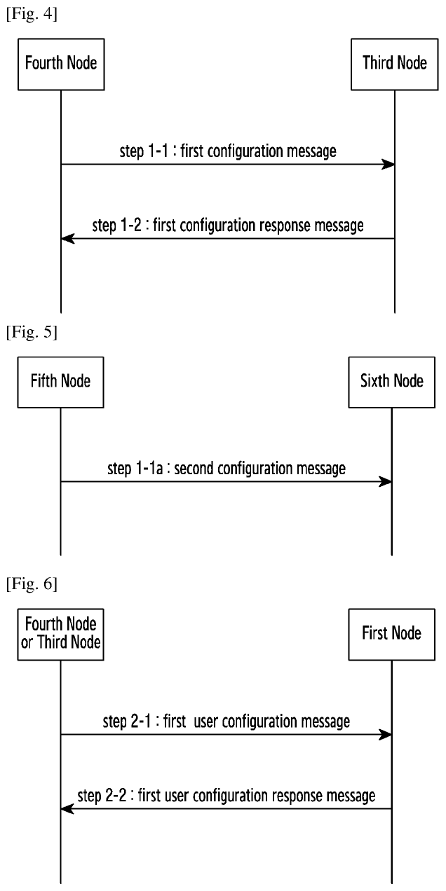

Further, when the fourth node is composed of the fifth node and the sixth node, the following steps may further included, as shown in FIG. 4:

Step 1-1a: the fifth node sends a second configuration message to the sixth node, which is used to configure data transmission of a user plane part of a centralized unit, and includes at least one of:
radio bearer identification information, such as DRB ID
sixth path indication information, which indicates a path used to transmit data (such as data indicated by the above radio bearer identification information). In an example, the information indicates a path of uplink data. In another example, the information indicates a path of downlink data. In another embodiment, the information indicates a path of the uplink and downlink data when the same path is employed for the uplink data and the downlink data. In another example, the information may also be used to indicate an uplink path and a downlink path respectively when different paths are employed for the uplink data and the downlink data. For an indicated path, as to the content contained in the information, the above “path indication information” may be referred to.
ninth condition information, which is used to indicate condition information for enabling a transmission path to serve a bearer identified by the above “radio bearer identification information”. For the specific description of the information, the above “condition indication information” may be referred to.
third tunnel information, which indicates configuration information of a tunnel serving a radio bearer at the third node or the sixth node side. The third tunnel information may include information of one or more tunnels, and for one tunnel, the third tunnel information includes at least one of:
transport layer address information, such as IP address
tunnel endpoint identification information, such as tunnel endpoint ID
seventh path indication information, which indicates a path used to transmit data, which may be data carried by the above tunnel, such as data carried on the tunnel indicated by the above transport layer address and/or tunnel endpoint identification information, or data carried on a downlink tunnel corresponding to the tunnel indicated by the above transport layer address and/or tunnel endpoint identification information, and the path indicated by the indication information may be a direct path, or an indirect path, or the direct path and the indirect path, or path identification information. In an example, the information indicates a path of uplink data. In another example, the information indicates a path of downlink data. In another embodiment, the information indicates a path of the uplink and downlink data. Further, when different paths are used for the uplink data and the downlink data, the information may also be used to include path indication information of the uplink data (such as the direct path, the indirect path, or the direct path and the indirect path, or identification information of the path) and path indication information of the downlink data (such as the direct path, the indirect path, or the direct path and the indirect path, or identification information of the path), and for the content contained in the information, the above “path indication information” may be referred to
tenth condition information, which is used to indicate condition information for enabling a transmission path to serve data on a tunnel. For the specific description of the information, the above “condition indication information” may be referred to. Further, the condition information may also be regarded as a condition for enabling a tunnel for data sending.

Through the above second configuration message, the sixth node may know the path used to transmit the data of the user terminal and the condition for enabling the corresponding path for data transmission, so as to determine the path transmitting the data for the user.

In the above procedures, the first configuration message may be a UE CONTEXT SETUP/MODIFICATION REQUEST message of the F1 interface or a packet transmitted on the user plane (such as a packet transmitted on the tunnel serving user data on the F1 interface, that is, the information contained in the first configuration message will be contained in the packet). The first configuration response message may be a UE CONTEXT SETUP/MODIFICATION RESPONSE message of the F1 interface, and the second configuration message may be a BEARER CONTEXT SETUP/MODIFICATION REQUEST message of an E1 interface. Of course, in the actual communication system, the above messages may also be other existing messages or newly defined messages.

The above procedure 1 has the advantageous effect that the configuration of the user transmission path can be generated, the third node can be configured to select an appropriate transmission path serving the user terminal (the first node), and the sixth node can be configured to select an appropriate path for data transmission, thereby improving the reliability and throughput of the user data transmission.

### Procedure 2: The Network Configures a Path of the User Terminal

In order to support flexible path selection, the invention gives the following procedures, so that the network sends configuration information related to a transmission path to the user terminal, which can help the user terminal to select an appropriate path for data transmission according to the configuration of the network. The following procedure can be used for the network side node to send the configuration information related to the transmission path to the first node, or for the network side node to send updated or modified transmission path configuration information to the first node when it is necessary to update or modify transmission path configuration information of the first node in a case where the configuration information related to the transmission path has been previously sent to the first node. The procedure includes the following steps, as shown in FIG. 5:

Step 2-1: the fourth node (or the third node) sends a first user configuration message to the first node. When the fourth node sends the first user configuration message, the fourth node may send it to the user terminal through the third node (through a direct path), or the fourth node may also send it to the user terminal through the third node and the second node (through an indirect path). The first user configuration message includes at least one of:
sixth path configuration information, which indicates a new path configured for the first node. The path may be a newly added path or a new path replacing the existing path. For the content of the information, the above “path configuration information” may be referred to
second primary path configuration information, which indicates information of a primary path configured for the first node. The primary path may be a direct path, or an indirect path. The primary path may be a primary path with respect to all data, a primary path with respect to partial data (such as data carried by an SRB, data carried by a DRB), or a primary path with respect to a radio bearer. For a primary path, the second primary path configuration information includes at least one of:
path identification information, which indicates an identification of the primary path.
path type information, which indicates whether the primary path is a direct path or an indirect path
logical channel identification information, a logical channel identified by the information is for the primary path and may be a logical channel on an air interface link or a logical channel on a sidelink
RLC entity identification information, an RLC entity identified by the information is for the primary path and may be an RLC entity on an air interface link or an RLC entity on a sidelink
path state indication information, which indicates a state of the path serving the user. In an embodiment, the path state indication information indicates an initial state of the path. For a path, the path state indication information includes at least one of:
path identification information
path type information, which indicates whether the path is a direct path or an indirect path
path operation information, which indicates an operation for the path, such as activating the path or deactivating the path. The first node may activate or deactivate the path according to the information.
path state information, which indicates a state of the path, for example, whether it may be used or whether it has been activated.
second state indication information, which indicates a state of a PDCP duplication function. In an embodiment, the second state indication information indicates an initial state, and includes at least one of:
first operation information which indicates activation or deactivation of the PDCP duplication function.
first primary path information, which indicates whether a primary path serving the PDCP duplication function is a direct path or an indirect path, or which of the paths configured to the user the primary path serving the PDCP duplication function is (which may be indicated by the path identification information, the logical channel identification, or the RLC entity identification)
eighth condition indication information, which indicates condition information for enabling a path serving the first node. In an embodiment, the condition information may be for all data serving the user, or for partial data serving the user (such as data carried by an SRB and data carried by a DRB), or with respect to a radio bearer. The enabled path may be a direct path, an indirect path, a secondary path, or a specific path (such as a path identified by the path identification information). For the content of the information, the above “condition indication information” may be referred to.

Further, when the above first user configuration message is sent by the fourth node, the message may be an RRC message; when the first user configuration message is sent by the third node, the information in the message may be contained in a packet (such as a MAC CE (Control element), or a PDU of an RLC layer, or a PDU of a MAC layer, or a PDU of an adaptation layer above the RLC layer (such as sidelink relay adaptation protocol layer)) sent by the third node to the user terminal, and sent by the third node to the first node through the direct path, or sent by the third node to the first node through the second node. After receiving the above first user configuration message, the first node may determine whether to activate the direct path and/or the indirect path, or whether to enable a certain path.

Further, optionally, step 2-2 may be further included: the first node sends a first user configuration response message to the fourth node (or the third node), which is used to respond to the first user configuration message.

Further, after the first node receives the first user configuration message, the first node may have one of the following behaviors:
establishing the direct path according to the received information, such as starting a random access procedure to establish the direct path with the fourth node (or the third node)
establishing the indirect link according to the received information, such as establishing a sidelink with the second node, and then establishing the direct path with the fourth node (or the third node) through the second node.
performing data transmission on the configured path according to the received information, such as performing the data transmission through the direct path, performing the data transmission through the indirect path, etc.

The above procedure 2 may be combined with procedure 1. In an example, step 2-1 may be performed after step 1-1 or step 1-2, so that the network side configures the path to the first node after determining the configuration of the path, as shown in FIG. 6.

In the above procedures, if the first user configuration message is an RRC message, it may be an RRCReconfiguration message, other existing message, or a newly defined message. The first user configuration response message may be an RRCReconfigurationComplete message, other existing message, or a newly defined message.

The above procedure 2 has the advantageous effect that the user can be configured with a suitable transmission path, and the user can also be configured to select the suitable transmission path, thereby improving the reliability and throughput of the user data transmission.

### Procedure 3: Indication and Recovery of Path Failure

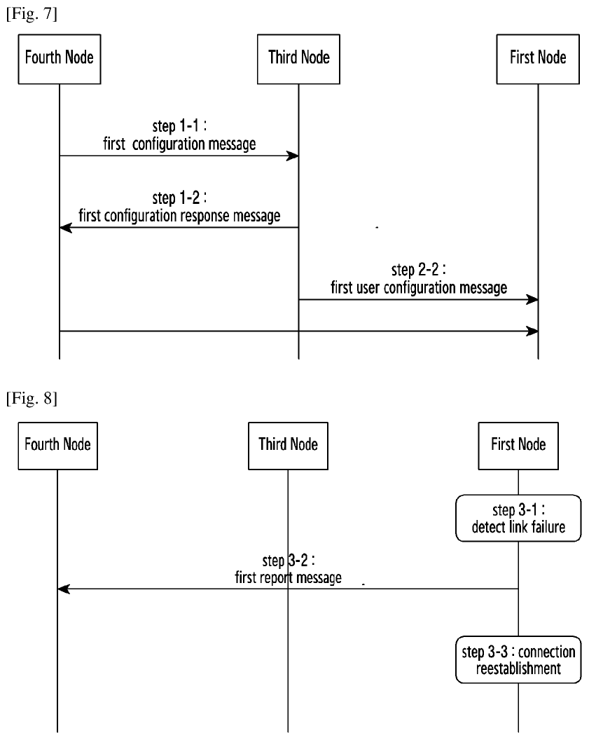

After configuring more than one path for the user terminal (the first node), the user terminal may detect failure of part of the paths (such as one path) or all the paths. When a path fails, the network side may not know it in time, and then continue transmitting data for the user by using the failed path, resulting in the loss of packets. In order to avoid this problem, the invention gives a procedure of indication and recovery of path failure, which includes the following steps, as shown in FIG. 7:

Step 3-1: the first node determines failure of the path, which may be detected by the first node or known through other nodes (such as the second node, that is, the second node informs the first node). In an embodiment, the first node detects the direct path to determine whether the direct path fails. In another embodiment, the first node detects the sidelink between the second node and the first node on the indirect path to determine whether the indirect path fails. In another embodiment, the first node knows whether the indirect path fails through the information sent by the second node, which indicates whether the air interface link between the second node and the network on the indirect path fails;

Step 3-2: the first node sends a first report message to the fourth node, which is used to inform the fourth node of information on link failure. In an embodiment, the first report message is sent to the fourth node through the direct path. In another embodiment, the first report message is sent to the fourth node through the indirect path. Further, the first report message may be sent to the third node first, and then sent by the third node to the fourth node. The first report message includes at least one of:
first type information, which indicates a type of occurred link failure. The failure type indicated by the information may be one of:
direct path failure indication information, which indicates that the link where the link failure occurs is a direct path
indirect path failure indication information, which indicates that the link where the link failure occurs is an indirect path. Further, the indication information may also indicate that the link failure occurs in the sidelink or the air interface link
failed link indication information, which indicates the link where the link failure occurs, such as link/path identification information
first cause information, which indicates a reason why the link failure occurs, such as timer timeout, random access failure, RLC layer retransmission times exceeding a maximum value, air interface link failure on the indirect link, sidelink failure on the indirect link, etc.

Optionally, step 3-3: the first node performs connection reestablishment. This step occurs after the first node detects (or determines) the link failure. The first node may determine whether to trigger the reestablishment according to the link where the link failure occurs. In an embodiment, the first node will initiate the connection reestablishment after detecting (or determining) the direct path failure. In another embodiment, the first node will initiate the connection reestablishment after detecting (or determining) the indirect path failure. In another embodiment, the first node will initiate the connection reestablishment after detecting (or determining) the direct path and indirect path failure. In another embodiment, when the first node detects (or determines) primary path failure, the connection reestablishment is initiated (the configuration of the primary path may be completed through the above procedures 1 and 2). In this step, the first node is directly connected to the network, and when the primary cell (such as PCell) accessed by the first node fails, the first node will trigger the reestablishment process; however, in the above step 3-3, the first node is required to determine whether to trigger the reestablishment according to the link where the link failure occurs, which can avoid unnecessary reestablishment and ensure the continuity of data transmission of the user terminal. In addition, the above step 3-2 may occur before step 3-3. For example, when at least one link of the first node does not fail, the first node may utilize the link that does not fail to send the first report message. The above step 3-2 may also occur after step 3-3. For example, when all links of the first node fail, the first node may wait for the connection reestablishment before sending the first report message.

Optionally, before step 3-1, it may also include a third configuration message transmitted by the fourth node to the first node, which is used to indicate a behavior of the user after the link failure occurs. The message includes at least one of:
reestablishment indication information, which indicates a condition where the user is required to reestablish, such as failure of the direct path, failure of the indirect path, failure of the primary path, failure of the secondary path, failure of a specific path (which is indicated by path-related information contained in the indication information, such as at least one of the path identification information, the identification information of the SpCell and the identification information of the relay user). After receiving the information, the user may determines whether to initiate a reestablishment procedure based on the path where the failure occurs.
indication information of failure report, which indicates a path where the user reports the failure, such as the direct path, the indirect path, the primary path, the secondary path, the specific path (which is indicated by path-related information contained in the indication information, such as at least one of the path identification information, the identification information of the SpCell and the identification information of the relay user). After receiving the information, the user may use the indicated path to report the failure information.

Optionally, after step 3-2, step 3-4 may be further included, as shown in FIG. 8: the fourth node sends a first configuration update message to the third node, which is used to update configuration of the third node according to the link failure of the first node, such as configuring data transmission of the third node according to the link that fails, and includes at least one of:
eighth path indication information, which indicates the configured path, such as direct path, indirect path, path identification information.
second operation information, which indicates an operation for the path, such as stopping data transmission through the direct path, stopping data transmission through the indirect path, stopping data transmission through a certain path (the information may also include the path identification information).

In the above procedures, the first report message may be a FailureInformation message, a UEInformationResponse message, other existing RRC message, or a newly defined message. The first configuration update message may be a UE CONTEXT MODIFICATION REQUEST message of the F1 interface, other existing message, or a newly defined message.

The above procedure 3 has the advantageous effect that it helps the network side to know the link where the user has link failure, thereby controlling the transmission of the user data and avoiding the loss of the data.

FIG. 10 illustrates a schematic block diagram of a communication device 1000 according to various embodiments of the disclosure, wherein the communication device may be configured to implement any one or more of the methods according to various embodiments of the disclosure. Therefore, it should be understood that the communication device 1000 may be the first node, the second node, the third node, the fourth node, the fifth node, the sixth node described in the disclosure or a part of any of the aforementioned nodes. It should be understood that the communication device 1000 may be a remote user terminal, a relay node or a relay device or a relay terminal or a part thereof, or may be a base station (e.g., a 5G base station (e.g., gNB, ng-eNB), or a 4G base station (e.g., eNB), or other types of access nodes) or a part thereof (e.g., a distributed unit (DU), a centralized unit (CU), a control plane part of the centralized unit, a user plane part of the centralized unit of the base station, etc.).

As shown in FIG. 10, the communication device 1000 includes a transceiver 1001, a processor 1002 and/or a memory 1003.

The transceiver 1001 is configured to receive and/or send signals.

The processor 1002 is operatively connected to the transceiver 1001 and the memory 1003. The processor 1002 may be implemented as one or more processors for operating according to any one or more of the methods described in various embodiments of the disclosure.

The memory 1003 is configured to store computer programs and data. The memory 1003 may include a non-transitory memory for storing operations and/or code instructions executable by the processor 1002. The memory 1003 may include non-transitory programs and/or instructions readable by the processor, which, when executed, cause the processor 1002 to implement the steps of any one or more of the methods according to various embodiments of the disclosure. The memory 1003 may further include a random access memory or buffer(s) to store intermediate processing data from various functions performed by the processor 1002.

According to an embodiment, a method performed by a fourth node in a communication system is provided. The method may comprise sending first information related to path configuration to a first node. The first information includes at least one of sixth path configuration information used to configure a path for the first node, second primary path configuration information used to indicate configuration information for one or more primary paths, path state indication information used to indicate a state of one or more paths, second state indication information used to indicate a state of a packet data convergence protocol (PDCP) duplication function, or eighth condition indication information used to indicate a condition for enabling a path.

For each of the one or more primary paths, the second primary path configuration information includes at least one of path identification information, path type information used to indicate whether the primary path is a direct path or an indirect path, logical channel identification information, or RLC entity identification information. For each of the one or more paths, the path state indication information includes at least one of path identification information, path type information, path operation information, or path state information. The second state indication information includes at least one of first operation information used to indicate activation or deactivation of the PDCP duplication function, and primary path information.

The method further comprises sending second information related to path configuration to a third node and receiving third information related to path configuration from the third node. The first information is determined based on at least one of the second information and the third information.

The second information includes at least one of first path configuration information used to indicate configuration information of one or more new paths configured or added for a user terminal, path release indication information, first condition indication information used to indicate a condition for enabling a path, first data transmission configuration information, signalling transmission configuration information, or first measurement information including a measurement result for one or more relay terminals. The third information includes at least one of path configuration result information used to indicate whether the path is accepted, fifth path configuration information used to indicate configuration information of a new path selected by the third node, first primary path configuration information used to indicate configuration information of one or more primary paths, fifth condition indication information used to indicate a condition for enabling a path, second data transmission configuration information, or link configuration information.

The path release indication information includes at least one of path identification information, indication information for releasing a direct path, indication information for releasing an indirect path, indication information for releasing a relay terminal, or indication information for releasing a special cell SpCell. The first data transmission configuration information includes at least one of radio bearer identification information, radio bearer QoS information, first resource mapping information, first path indication information, second condition indication information used to indicate a condition for enabling a path, or first tunnel information used to indicate configuration information of one or more tunnels serving a radio bearer at the fourth node side. The signalling transmission configuration information includes at least one of a signalling container, third path indication information, or fourth condition indication information used to indicate a condition for enabling a path. For each of the one or more relay terminals, the first measurement information includes at least one of cell identification information, relay terminal identification information, or measurement result information. For each primary path, the first primary path configuration information includes at least one of logical channel identification information, or RLC entity identification information. The second data transmission configuration information includes at least one of radio bearer identification information, third resource mapping information, fourth path indication information, sixth condition indication information used to indicate a condition for enabling a path, or second tunnel information used to indicate configuration information of one or more tunnels serving a radio bearer at the third node side. The link configuration information includes at least one of air interface link configuration information, or sidelink configuration information.

For each of the one or more tunnels, the first tunnel information includes at least one of transport layer address information, tunnel endpoint identification information, second resource mapping information, second path indication information, or third condition indication information used to indicate a condition for enabling a path. For each of the one or more tunnels, the second tunnel information includes at least one of transport layer address information, tunnel endpoint identification information, fourth resource mapping information, fifth path indication information, or seventh condition indication information, which is used to indicate a condition for enabling a path.

The path configuration information includes at least one of path identification information, path type information, cell identification information, relay terminal identification information, timer information, path characteristic indication information used to indicate whether the path is a primary path or a secondary path, first path state information used to indicate whether the path is available, or is activated, or first path maintenance information used to indicate whether to maintain data transmission on other paths. A condition indicated by the condition indication information includes at least one of an amount of transmitted data being greater than or less than a first threshold, signal quality being greater than or less than a second threshold, data transmission rate being greater than or less than a third threshold, or time delay of data transmission being greater than or less than a fourth threshold.

The method further comprises receiving information related to link failure from the first node. The information related to link failure includes at least one of link failure type indication information, or link failure cause information. The link failure type indication information includes at least one of direct path failure indication information, indirect path failure indication information, or failed path indication information.

The indirect path failure indication information is used to indicate a sidelink failure or an air interface link failure.

According to an embodiment, a method performed by a first node in a communication system is provided, the method comprises receiving fourth information related to path configuration from other nodes, and sending information related to link failure to a fourth node. The fourth information includes path configuration information. The information related to link failure includes at least one of link failure type indication information or link failure cause information. The link failure type indication information includes at least one of direct path failure indication information, indirect path failure indication information, failed path indication information or link failure cause information.

The path configuration information includes at least one of path identification information, path type information, cell identification information, relay terminal identification information, timer information, path characteristic indication information used to indicate whether a path is a primary path or a secondary path, first path state information used to indicate whether the path is available, or is activated, or first path maintenance information used to indicate whether to maintain data transmission on other paths.

The fourth message further includes at least one of second primary path configuration information used to indicate configuration information for one or more primary paths, path state indication information used to indicate a state of one or more paths, second state indication information used to indicate a state of a PDCP duplication function, or eighth condition indication information. A condition indicated by the eighth condition indication information includes at least one of an amount of transmitted data being greater than or less than a first threshold, signal quality being greater than or less than a second threshold, data transmission rate being greater than or less than a third threshold, or time delay of data transmission being greater than or less than a fourth threshold.

According to an embodiment, a method performed by a third node in a communication system is provided. The method comprises receiving second information related to path configuration from a fourth node, sending third information related to path configuration to the fourth node, and sending first information related to path configuration to a first node. The first information is determined based on at least one of the second information and the third information.

The second information includes at least one of first path configuration information used to indicate configuration information of one or more new paths configured or added for a user terminal, path release indication information, first condition indication information, first data transmission configuration information, signalling transmission configuration information, or first measurement information including a measurement result for one or more relay terminals. The third information includes at least one of path configuration result information used to indicate whether a path is accepted, fifth path configuration information used to indicate configuration information of a new path selected by the third node, first primary path configuration information used to indicate configuration information of one or more primary paths, fifth condition indication information, second data transmission configuration information, or link configuration information.

According to an embodiment, a node device is provided. The node device comprises a transceiver; and a processor configured to send first information related to path configuration to a first node. The first information includes at least one of sixth path configuration information used to configure a path for the first node, second primary path configuration information used to indicate configuration information for one or more primary paths, path state indication information used to indicate a state of one or more paths, second state indication information used to indicate a state of a packet data convergence protocol (PDCP) duplication function, or eighth condition indication information used to indicate a condition for enabling a path.

The first threshold, the second threshold, the third threshold, and the fourth threshold are different or partially different from each other. The condition indication information further includes one or more of the first threshold, the second threshold, the third threshold, and the fourth threshold. The path indication information includes at least one of path identification information, path flag information used to indicate that a path used to transmit data includes a direct path, or an indirect path, or both, second path state information used to indicate whether a path for transmitting data is available, or is activated, or second path maintenance information used to indicate whether to maintain data transmission on other paths.

The method further comprises sending configuration update information to a third node. The configuration update information includes at least one of: eighth path indication information and second operation information used to indicate an operation for the path.

According to an embodiment of the disclosure, a first node device is provided. The first node device comprises a transceiver and a processor coupled to the transceiver and configured to perform the methods according to the embodiments of the disclosure that are performed by the first node.

According to an embodiment of the disclosure, a third node device is provided. The third node device comprises a transceiver; and a processor coupled to the transceiver and configured to perform the methods according to the embodiments of the disclosure that are performed by the third node.

According to an embodiment of the disclosure, a fourth node device is provided. The fourth node device comprises a transceiver; and a processor coupled to the transceiver and configured to perform the methods according to the embodiments of the disclosure that are performed by the fourth node.

According to an embodiment of the disclosure, a machine-readable storage medium having instructions stored thereon is provided. The instructions, when executed by a processor, cause the processor to perform the methods according to various embodiments of the disclosure.

FIG. 11 illustrates a structure of a UE according to an embodiment of the disclosure.

As shown in FIG. 11, the UE according to an embodiment may include a transceiver 1110, a memory 1120, and a processor 1130. The transceiver 1110, the memory 1120, and the processor 1130 of the UE may operate according to a communication method of the UE described above. However, the components of the UE are not limited thereto. For example, the UE may include more or fewer components than those described above. In addition, the processor 1130, the transceiver 1110, and the memory 1120 may be implemented as a single chip. Also, the processor 1130 may include at least one processor. Furthermore, the UE of FIG. 11 corresponds to the UE 101 of the FIG. 1, respectively.

The transceiver 1110 collectively refers to a UE receiver and a UE transmitter, and may transmit/receive a signal to/from a base station or a network entity. The signal transmitted or received to or from the base station or a network entity may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor 1130, a signal through a wireless channel, and transmit a signal output from the processor 1130 through the wireless channel.

The memory 1120 may store a program and data required for operations of the UE. Also, the memory 1120 may store control information or data included in a signal obtained by the UE. The memory 1120 may be a storage medium, such as read-only memory (ROM), random access memory (RAM), a hard disk, a CD-ROM, and a DVD, or a combination of storage media.

The processor 1130 may control a series of processes such that the UE operates as described above. For example, the transceiver 1110 may receive a data signal including a control signal transmitted by the base station or the network entity, and the processor 1130 may determine a result of receiving the control signal and the data signal transmitted by the base station or the network entity.

FIG. 12 illustrates a structure of a base station according to an embodiment of the disclosure.

As shown in FIG. 12, the base station according to an embodiment may include a transceiver 1210, a memory 1220, and a processor 1230. The transceiver 1210, the memory 1220, and the processor 1230 of the base station may operate according to a communication method of the base station described above. However, the components of the base station are not limited thereto. For example, the base station may include more or fewer components than those described above. In addition, the processor 1230, the transceiver 1210, and the memory 1220 may be implemented as a single chip. Also, the processor 1230 may include at least one processor. Furthermore, the base station of FIG. 12 corresponds to the base station (eNodeB/NodeB) included in E-UTRAN 102 of the FIG. 1, respectively.

The transceiver 1210 collectively refers to a base station receiver and a base station transmitter, and may transmit/receive a signal to/from a terminal (UE) or a network entity. The signal transmitted or received to or from the terminal or a network entity may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor 1230, a signal through a wireless channel, and transmit a signal output from the processor 1230 through the wireless channel.

The memory 1220 may store a program and data required for operations of the base station. Also, the memory 1220 may store control information or data included in a signal obtained by the base station. The memory 1220 may be a storage medium, such as read-only memory (ROM), random access memory (RAM), a hard disk, a CD-ROM, and a DVD, or a combination of storage media.

The processor 1230 may control a series of processes such that the base station operates as described above. For example, the transceiver 1210 may receive a data signal including a control signal transmitted by the terminal, and the processor 1230 may determine a result of receiving the control signal and the data signal transmitted by the terminal.

Those of ordinary skill in the art will recognize that the description of the methods for communication configuration of the disclosure is only illustrative and is not intended to be limited in any way. Other embodiments will be readily apparent to those of ordinary skill in the art having the benefit of the disclosure.

For the sake of clarity, not all conventional features of the implementations of the methods and devices related to communication configuration of the disclosure are shown and described. Of course, it should be understood that in the development of any such actual implementations of the methods and devices related to communication configuration, in order to achieve the specific goals of the developers, such as conforming to the constraints related to applications, systems, networks and businesses, many implementation-specific decisions may need to be made, and these specific goals will vary with different implementations and developers.

The modules, processing operations and/or data structures described according to the disclosure may be implemented using various types of operating systems, computing platforms, network devices, computer programs and/or general-purpose machines. In addition, those skilled in the art will recognize that less general-purpose devices such as hard-wired devices, Field Programmable Gate Array (FPGA), Application Specific Integrated Circuits (ASIC), etc. may also be used. In the case that a method including a series of operations and sub-operations is implemented by a processor, computer or machine, and those operations and sub-operations may be stored as a series of non-transitory code instructions readable by the processor, computer or machine, they may be stored on a tangible and/or non-transitory medium.

The modules of the methods and devices related to communication configuration described herein may include software, firmware, hardware or any combination(s) of software, firmware or hardware suitable for the purpose described herein.

In the methods related to communication configuration described herein, various operations and sub-operations may be performed in various orders, and some of the operations and sub-operations may be optional.

Although the foregoing disclosure of the present application has been made by non-limiting illustrative embodiments, these embodiments may be arbitrarily modified within the scope of the appended claims without departing from the spirit and nature of the disclosure.

1-15. (canceled)

16. A method performed by a distributed unit (DU) of a base station in a wireless communication system, the method comprising:
receiving, from a central unit (CU) of the base station, a first message including first configuration information on a path switch for a user equipment (UE) from a direct path to an indirect path associated with a relay UE; and
transmitting, to the CU, a second message as a response to the first message,
wherein the first configuration information includes information on an identity (ID) of the relay UE.

17. The method of claim 16, further comprising:
receiving, from the CU, a third message including second configuration information on the path switch; and
transmitting, to the UE, the third message.

18. The method of claim 17, wherein the second configuration information includes information on a timer for the path switch, and
wherein a radio resource control (RRC) re-establishment procedure associated with the base station is based on an expiry of the timer.

19. The method of claim 16, wherein the second message includes cell group configuration information for the UE.

20. A distributed unit (DU) of a base station in a wireless communication system, the DU comprising:
a transceiver; and
a controller coupled with the transceiver and configured to:
receive, from a central unit (CU) of the base station, a first message including first configuration information on a path switch for a user equipment (UE) from a direct path to an indirect path associated with a relay UE, and
transmit, to the CU, a second message as a response to the first message,
wherein the first configuration information includes information on an identity (ID) of the relay UE.

21. The DU of claim 20, wherein the controller is further configured to:
receive, from the CU, a third message including second configuration information on the path switch, and
transmit, to the UE, the third message.

22. The DU of claim 21, wherein the second configuration information includes information on a timer for the path switch, and
wherein a radio resource control (RRC) re-establishment procedure associated with the base station is based on an expiry of the timer.

23. The DU of claim 20, wherein the second message includes cell group configuration information for the UE.

24. A method performed by a central unit (CU) of a base station in a wireless communication system, the method comprising:
transmitting, to a distributed unit (DU) of the base station, a first message including first configuration information on a path switch for a user equipment (UE) from a direct path to an indirect path associated with a relay UE; and
receiving, from the DU, a second message as a response to the first message,
wherein the first configuration information includes information on an identity (ID) of the relay UE.

25. The method of claim 24, further comprising transmitting, to the DU, a third message including second configuration information on the path switch.

26. The method of claim 25, wherein the second configuration information includes information on a timer for the path switch, and
wherein a radio resource control (RRC) re-establishment procedure associated with the base station is based on an expiry of the timer.

27. The method of claim 24, wherein the second message includes cell group configuration information for the UE.

28. A central unit (CU) of a base station in a wireless communication system, the CU comprising:
a transceiver; and
a controller coupled with the transceiver and configured to:
transmit, to a distributed unit (DU) of the base station, a first message including first configuration information on a path switch for a user equipment (UE) from a direct path to an indirect path associated with a relay UE, and
receive, from the DU, a second message as a response to the first message,
wherein the first configuration information includes information on an identity (ID) of the relay UE.

29. The CU of claim 28, wherein the controller is further configured to:
transmit, to the DU, a third message including second configuration information on the path switch.

30. The CU of claim 29, wherein the second configuration information includes information on a timer for the path switch, and
wherein a radio resource control (RRC) re-establishment procedure associated with the base station is based on an expiry of the timer.

31. The CU of claim 28, wherein the second message includes cell group configuration information for the UE.
